(19) United States
(12) Patent Application Publication
(10) Pub. No.: US 2011/0236112 A1
(43) Pub. Date: Sep. 29, 2011

(54) PRINT SYSTEM

(75) Inventor: Tamotsu NISHIURA, Yokohama-shi (JP)

(73) Assignee: FUJI XEROX CO., LTD., Tokyo (JP)

(21) Appl. No.: 12/870,558

(22) Filed: Aug. 27, 2010

(30) Foreign Application Priority Data
Mar. 23, 2010 (JP) 2010-065449

(51) Int. Cl. B41J 11/42

(52) U.S. Cl. 400/583

(57) ABSTRACT

A print system includes: a first printer that performs printing on continuous form paper; a second printer that performs printing on the continuous form paper after the printing by the first printer; and a synchronization unit that synchronizes the printing by the first printer and the printing by the second printer.

### CROSS-REFERENCE TO RELATED APPLICATIONS

This application is based on and claims priority under 35 USC 119 from Japanese Patent Application No. 2010-065449 filed Mar. 23, 2010.

### BACKGROUND

### Technical Field

The present invention relates to a print system.

### SUMMARY

According to an aspect of the present invention, there is provided a print system including: a first printer that performs printing on continuous form paper; a second printer that performs printing on the continuous form paper after the printing by the first printer; and a synchronization unit that synchronizes the printing by the first printer and the printing by the second printer.

### BRIEF DESCRIPTION OF THE DRAWINGS

An exemplary embodiment of the present invention will be described in detail based on the following figures, wherein:

FIG. 1 illustrates a configuration of a print system according to an exemplary embodiment of the present invention;

FIG. 2 illustrates a hardware configuration of an upstream side printer in FIG. 1;

FIG. 3 is a block diagram showing a configuration of an upstream side control program;

FIG. 4 is a block diagram showing a configuration of a downstream side control program;

FIG. 5 is a sequence diagram showing operations (S10) of the upstream side printer and the downstream side printer in FIG. 1;

FIG. 6 is a timing chart showing operations of components of the upstream side printer and the downstream side printer; and

FIG. 7 is a timing chart showing effects of the print system according to the exemplary embodiment of the present invention.

### DETAILED DESCRIPTION

Hereinbelow, an exemplary embodiment of the present invention will be described in detail based on the drawings. Note that the following description is merely an example of implementation of the present invention and the present invention is not limited to the example described below but may be arbitrarily changed in accordance with necessity.

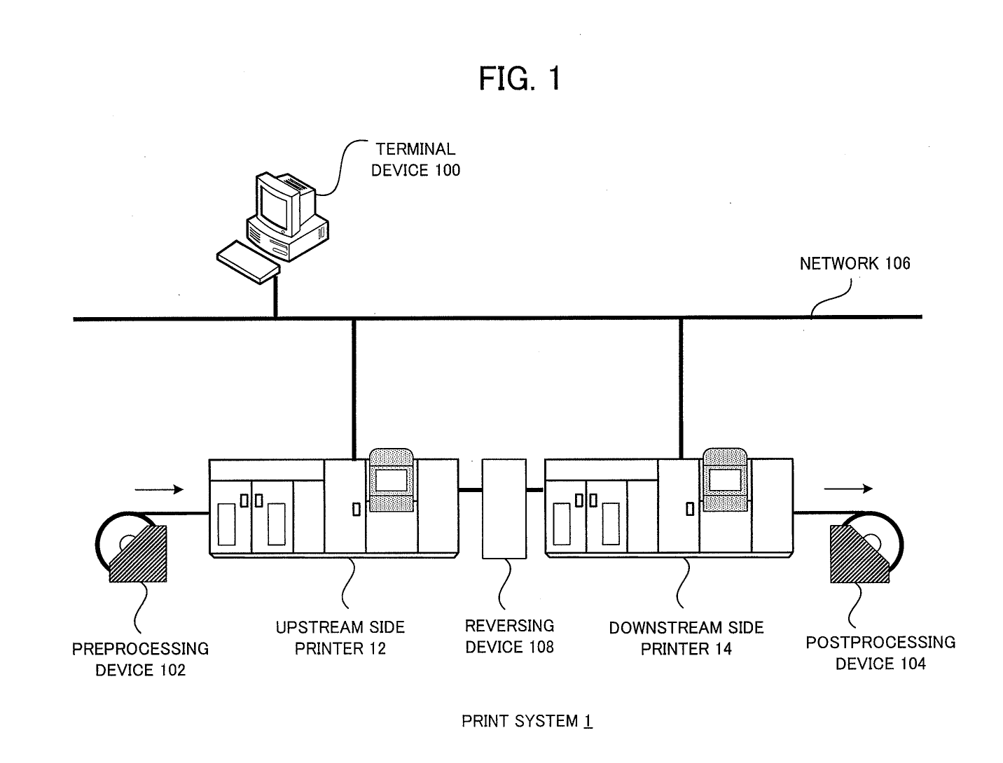

FIG. 1 illustrates a configuration of a print system 1 according to an exemplary embodiment of the present invention.

The print system 1 is an overlapped-continuous print system in which, e.g., plural printers are directly connected to perform printing on continuous form paper used in basic business or the like.

As shown in FIG. 1, the print system 1 has a terminal device 100 having general computer functions to generate a print command for printing on continuous form paper, a preprocessing device 102 to supply the continuous form paper, a printer 12 to perform printing on the front surface of the continuous form paper based on the print command from the terminal device 100, a printer 14 to perform printing on the rear surface of the continuous form paper based on the print command from the terminal device 100, and a postprocessing device 104 to rewind the continuous form paper.

These devices are communicably interconnected via a network 106. The devices other than the terminal device 100 are often directly connected, while the terminal device 100 and the other devices than the terminal device 100 are often connected via another device (rooter or the like).

A reversing device 108 to reverse the front surface of the continuous form paper to the rear surface is provided between the printer 12 and the printer 14. The continuous form paper supplied from the preprocessing device 102 is subjected to printing by the printer 12 on the front surface, then reversed from the front surface to the rear surface by the reversing device 108, and subjected to printing by the printer 14 on the rear surface.

Hereinbelow, the printer 12 will be referred to as an “upstream side printer 12”, and the printer 14, a “downstream side printer 14”.

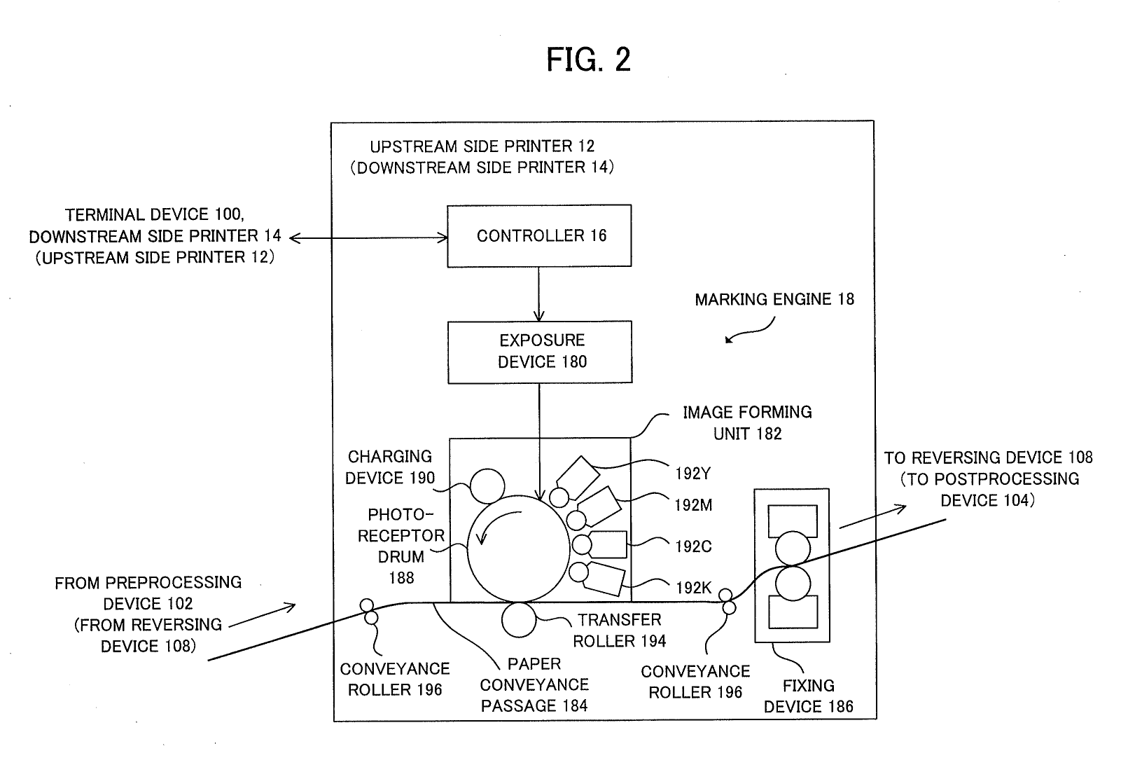

FIG. 2 illustrates a hardware configuration of the upstream side printer 12 in FIG. 1. Note that since the upstream side printer 12 and the downstream side printer 14 have basically the same hardware configuration, only the upstream side printer 12 will be described below.

As shown in FIG. 2, the upstream side printer 12 has a controller 16 and a marking engine 18.

The upstream side printer 12 having the above configuration generates print data based on a print command from the terminal device 100 in FIG. 1, and print-outputs the print data on continuous form paper at a previously-determined timing (hereinbelow, referred to as “predetermined timing”. The details of the timing will be described later).

The controller 16 is a control circuit board having e.g. a CPU, a memory, and a storage medium.

The controller 16 receives a print command via the network 106 in FIG. 1 from the terminal device 100, and generates print data. Further, the controller 16 controls the marking engine 18 so as to print-output the generated print data on the continuous form paper at the predetermined timing.

Note that a synchronizing signal indicating the predetermined timing is transmitted via the network 106 to the downstream side printer 14 (in the downstream side printer, the synchronizing signal indicating the predetermined timing is received via the network 106 from the upstream side printer 12).

Further, when an error is detected, the controller 16 controls the marking engine 18 so as to stop the printing on the continuous form paper.

The marking engine 18 is e.g. a direct transfer type digital color printer. The marking engine 18 has an exposure device 180, an image forming unit 182, a paper conveyance passage 184 and a fixing device 186.

The exposure device 180 is a multi-beam scan exposure device which collectively scans plural laser beams, emitted from a surface light-emission laser array chip having a light emission point group of plural light emission points, and guides the beams to a photoreceptor drum.

The image forming unit 182 has a photoreceptor drum 188 as an image holder to form an electrostatic latent image and hold a toner image, a charging device 190 to uniformly charge the surface of the photoreceptor drum 188, developing rollers 192Y (Yellow), 192M (Magenta), 192C (Cyan) and 192K (black) provided for colors forming a color image, and a transfer roller 194 to transfer the toner image formed on the surface of the photoreceptor drum to the continuous form paper.

The image forming unit 182 supplies toner corresponding to an output image from the developing rollers 192Y, 192M, 192C and 192K to the photoreceptor drum 188, generates toner images from the electrostatic latent image on the surface of the photoreceptor drum 188, and sequentially transfers the toner images to the continuous form paper.

The paper conveyance passage 184 is provided with plural pairs of conveyance rollers 196 along the paper conveyance passage 184. The continuous form paper supplied with the paper conveyance passage 184 from the preprocessing device 102 in FIG. 1 is subjected to printing on the front surface, then the printed surface is faced down, and conveyed to the reversing device 108 in FIG. 1 (in the downstream side printer 14, the continuous form paper with the printed front surface is supplied from the reversing device 108, then subjected to printing on the rear surface, then the printed surface is faced down, and conveyed to the postprocessing device 106 in FIG. 1).

The fixing device 186 fixes the toner image transferred to the continuous form paper.

Next, the controller 16 in FIG. 2 will be further described.

### [Program Executed on the Upstream Side Printer]

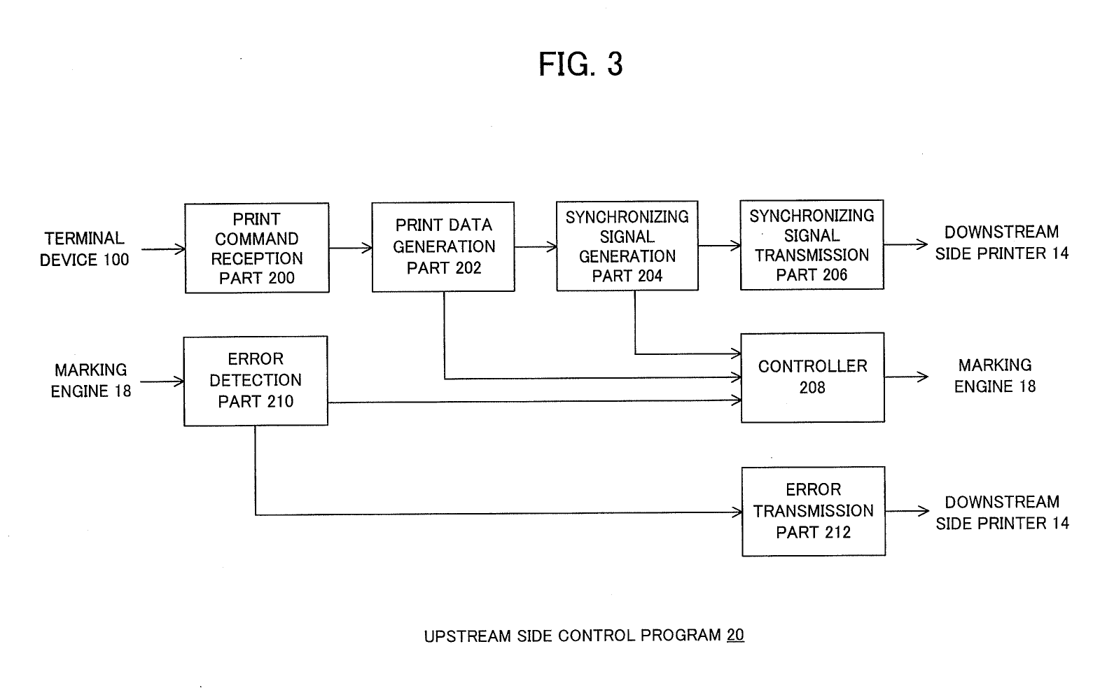

FIG. 3 is a block diagram showing a configuration of an upstream side control program 20 which operates in the controller 16 of the upstream side printer 12. The controller 16 causes the CPU to execute the upstream side control program 20 read from the memory, the storage medium or the like.

As shown in FIG. 3, the upstream side control program 20 has a print command reception part 200, a print data generation part 202, a synchronizing signal generation part 204, a synchronizing signal transmission part 206, a controller 208, an error detection part 210 and an error transmission part 212.

The print command reception part 200 receives a print command from the terminal device 100 in FIG. 1 via the network 106 in FIG. 1.

The print data generation part 202 generates print data based on the print command received by the print command reception part 200.

The synchronizing signal generation part 204 generates a synchronizing signal as a data signal indicating the length of continuous form paper conveyed with the paper conveyance passage 184 in FIG. 2 (hereinbelow, “paper feed length”), and a synchronizing signal as a data signal indicating the length of continuous form paper necessary for print-output of the print data (or image data, text data and the like forming the print data) generated by the print data generation part 202 (hereinbelow, “FCB (File Control Block) length”).

The synchronizing signal transmission part 206 transmits the synchronizing signals generated by the synchronizing signal generation part 204 via the network 106 to the downstream side printer 14 in FIG. 1.

The controller 208 controls the marking engine 18 in FIG. 2 so as to print-output the print data generated by the print data generation part 202 on the continuous form paper at a timing based on the synchronizing signals generated by the synchronizing signal generation part 204.

More particularly, the controller 208 controls the paper conveyance passage 184 in FIG. 2 so as to convey the continuous form paper at a timing based on the synchronizing signal as a data signal indicating the paper feed length, and controls the image forming unit 182 in FIG. 2 so as to generate a toner image at a timing based on the synchronizing signal as a data signal indicating the FCB length.

Further, the controller 208 controls the marking engine 18 so as to stop printing on the continuous form paper when an error is detected by the error detection part 210.

The error detection part 210 detects an error with high emergency (for example, paper jam caused by contamination of the conveyance rollers 196 in FIG. 2 or the like) among errors in the marking engine 18, and transmits the detected error to the controller 208 and the error transmission part 212.

The error transmission part 212 transmits the error detected by the error detection part 210 via the network 106 to the downstream side printer 14.

### [Program Executed on Downstream Side Printer]

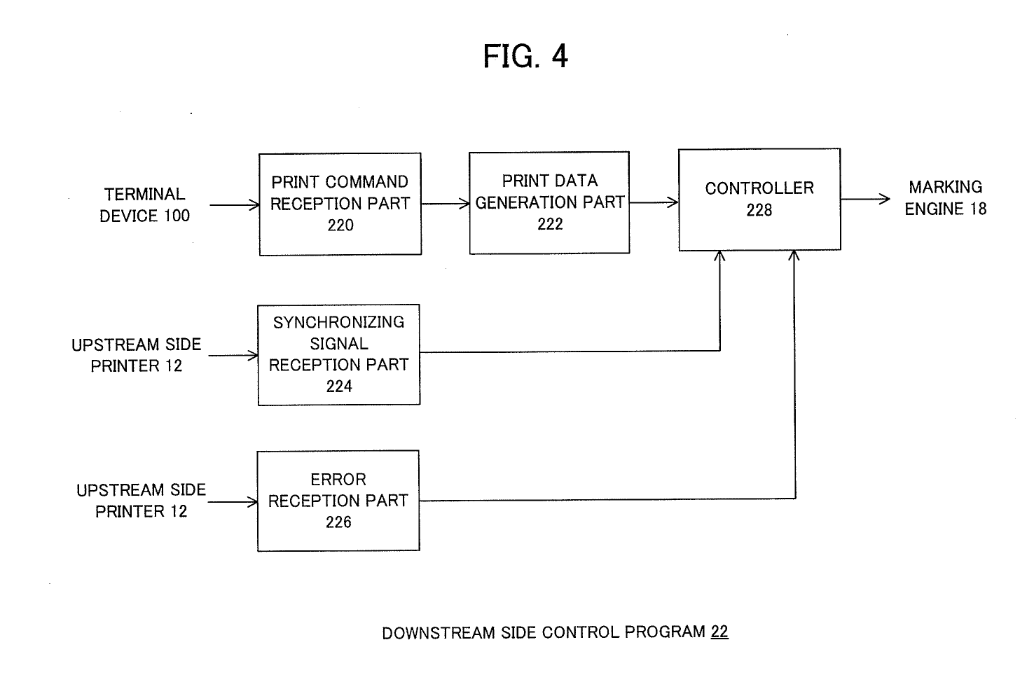

FIG. 4 shows a configuration of the downstream side control program 22 which operates in the controller 16 of the downstream side printer 14. The controller 16 causes the CPU to execute the downstream side control program 22 read from the memory, the storage medium or the like.

As shown in FIG. 4, the downstream side control program 22 has a print command reception part 220, a print data generation part 222, a synchronizing signal reception part 224, an error reception part 226 and a controller 228.

The print command reception part 220 receives a print command from the terminal device 100 in FIG. 1 via the network 106 in FIG. 1 as in the case of the print command reception part 200 in FIG. 3.

The print data generation part 222 generates print data based on the print command received by the print command reception part 220 as in the case of the print data generation part 202 in FIG. 3.

The synchronizing signal reception part 224 receives the synchronizing signals from the upstream side printer 12 in FIG. 1 via the network 106.

The error reception part 226 receives an error from the upstream side printer 12 via the network 106.

The controller 228 controls the marking engine 18 in FIG. 2 so as to print-output the print data generated by the print data generation part 222 on the continuous form paper at timings based on the synchronizing signals received by the synchronizing signal reception part 224.

Further, the controller 228 controls the marking engine 18 so as to stop the printing on the continuous form paper when an error is received by the error reception part 226.

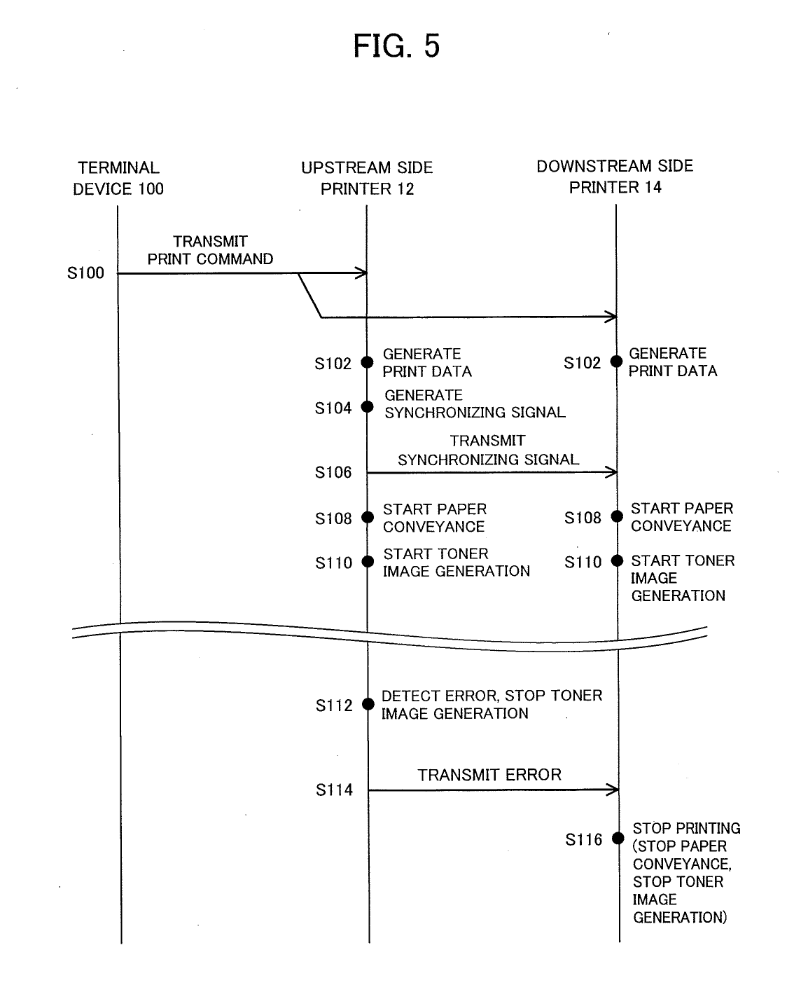

FIG. 5 is a sequence diagram showing operations (S10) of the upstream side printer 12 and the downstream side printer 14 in FIG. 1.

Note that steps S100 to S110 indicate operations at normal times, while steps S112 to S116 indicate operations upon occurrence of an error.

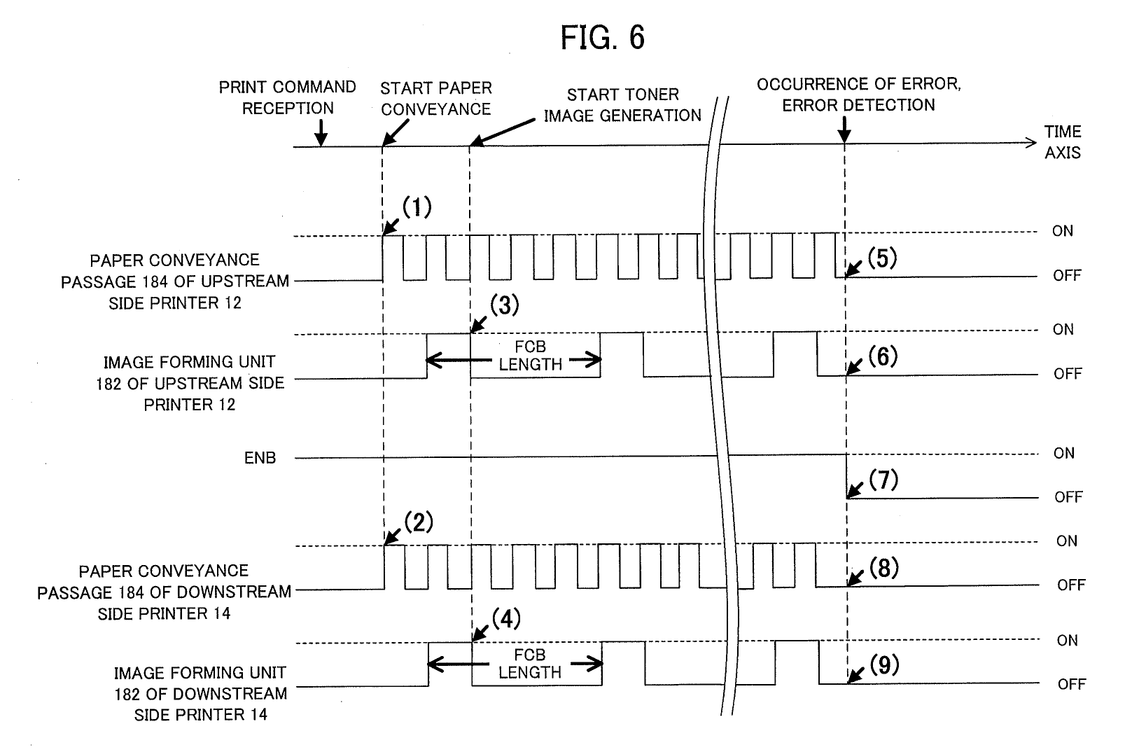

Further, FIG. 6 is a timing chart showing operations of components (here the paper conveyance passage 184 and the image forming unit 182 in FIG. 2) of the upstream side printer 12 and the downstream side printer 14.

As shown in FIG. 5, at step S100, the upstream side printer 12 receives a print command from the terminal device 100 in FIG. 1 in the print command reception part 200 in FIG. 3.

Further, the downstream side printer 14 also receives the print command from the terminal device 100, in the print command reception part 220 in FIG. 4.

At step S102, the upstream side printer 12 generates print data based on the print command received at step S100 in the print data generation part 202 in FIG. 3.

Further, the downstream side printer 14 also generates print data based on the print command received at step S100, in the print data generation part 222 in FIG. 4.

Note that at steps S100 and S102, the upstream side printer 12 and the downstream side printer 14 both receive the print command and generate the print data; however, it may be arranged such that a host controller or the like is provided between the terminal device 100 and the upstream side printer 12, and the downstream side printer 14, and the host controller receives the print command once then generates print data, and transmits the generated print data to the upstream side printer 12 and the downstream side printer 14.

At step S104, the upstream side printer 12 generates a synchronizing signal as a data signal indicating the paper feed length and a synchronizing signal as a data signal indicating the FCB length in the synchronizing signal generation part 204 in FIG. 3.

At step S106, the upstream side printer 12 transmits the synchronizing signals generated at step S104 to the downstream side printer 14, in the synchronizing signal transmission part 206 in FIG. 3.

At step S108, the upstream side printer 12 and the downstream side printer 14 convey the continuous form paper on the paper conveyance passage 184 in FIG. 1, at a timing based on the synchronizing signal as a data signal indicating the paper feed length generated at step S104 (or received at step S106).

That is, as shown in (1) and (2) in FIG. 6, the upstream side printer 12 and the downstream side printer 14 convey the continuous form paper at the same timing.

At step S110, the upstream side printer 12 and the downstream side printer 14 generate toner images based on the print data generated at step S102, at a timing based on the synchronizing signal as a data signal indicating the FCB length generated at step S104 (or received at step S106), in the image forming unit 182 in FIG. 1.

That is, as shown in (3) and (4) in FIG. 6, the upstream side printer 12 and the downstream side printer 14 generate toner images at the same timing.

At step S112, when an error occurs in the upstream side printer 12, the upstream side printer 12 detects the error in the error detection part 210 in FIG. 3. For example, as shown in (5) in FIG. 6, when paper jam occurs at the conveyance rollers 196 in FIG. 2 and conveyance of the continuous form paper is stopped on the conveyance passage 184, the error detection part 210 detects the error.

At this time, as shown in (6) in FIG. 6, the upstream side printer 12 stops the toner image generation in the image forming unit 182.

Note that at this time, as shown in (7) in FIG. 6, it may be arranged such that the upstream side printer 12 turns an enable signal (ENB) off, and transmits such change of the enable signal to the downstream side printer 14.

At step S114, the upstream side printer 12 transmits the error detected at step S112 to the downstream side printer 14 in the error transmission part 212 in FIG. 3.

At step S116, the downstream side printer 14 stops the printing on the continuous form paper based on the error received at step S114, in the marking engine 18 in FIG. 1.

That is, as shown in (8) in FIG. 6, the downstream side printer 14 stops the conveyance of the continuous form paper in the paper conveyance passage 184, and as shown in (9) in FIG. 6, stops the toner image generation in the image forming unit 182.

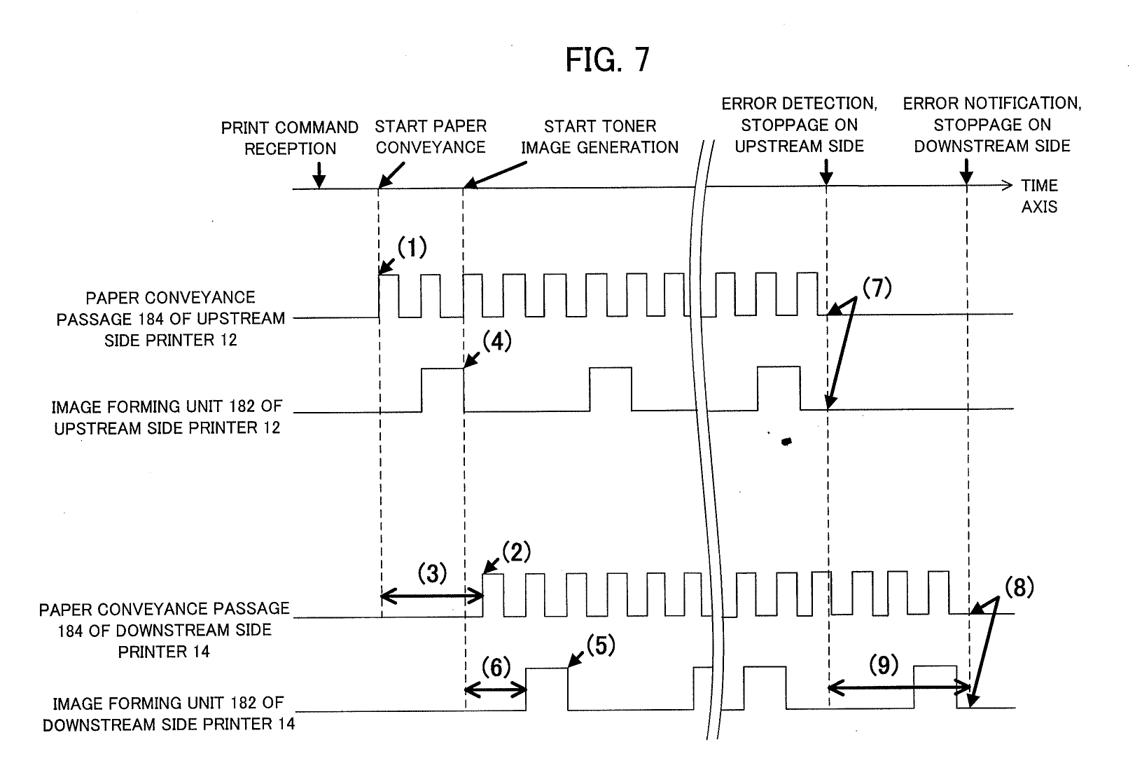

Hereinbelow, effects obtained by the print system 1 according to the exemplary embodiment of the present invention will be described with reference to FIG. 7.

FIG. 7 is a timing chart showing a case where the upstream side printer 12 and the downstream side printer 14 operate independently. As shown in (1) and (2), since the upstream side printer 12 and the downstream printer 14 independently start conveyance of continuous form paper, a shift shown in (3) occurs.

Further, as shown in (4) and (5), since the upstream side printer 12 and the downstream side printer 14 independently start toner image generation, a shift shown in (6) occurs.

Further, as shown in (7), when an error in the upstream side printer 12 is detected and the upstream side printer 12 stops printing on the continuous form paper, then the downstream side printer 14 stops the printing on the continuous form paper as shown in (8). A shift shown in (9) occurs because the downstream side printer 14 is notified of the error in the upstream side printer 12 via the terminal device 100 in FIG. 1, a host controller (not shown) or the like.

By the occurrence of such shift, it is necessary for the user to provide a buffer unit to loose the continuous form paper by a predetermined length in the reversing device 108 in FIG. 1, or upon occurrence of an error, to re-adjust the looseness of the continuous form paper (paper buffer).

On the other hand, in the print system according to the exemplary embodiment of the present invention, since the upstream side printer 12 and the downstream side printer 14 operate at timings based on the synchronizing signals, the shifts shown in (3) and (6) can be reduced. Further, since an error is transmitted from the upstream side printer 12 to the downstream side printer 14, the shift shown in (9) can be reduced.

That is, the paper buffer can be reduced, and a buffer unit provided for the paper buffer is unnecessary, and further, even upon occurrence of an error, readjustment of the paper buffer is unnecessary.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print system comprising:
a first printer that performs printing on continuous form paper;
a second printer that performs printing on the continuous form paper after the printing by the first printer; and
a synchronization unit that synchronizes the printing by the first printer and the printing by the second printer.

2. The print system according to claim 1, wherein the synchronization unit synchronizes stoppage of the printing by the first printer and stoppage of the printing by the second printer.

3. The print system according to claim 1,
wherein the first printer has:
a synchronizing signal generation unit that generates a synchronizing signal;
a synchronizing signal transmission unit that transmits the synchronizing signal generated by the synchronizing signal generation unit to the second printer; and
a first controller that controls the first printer so as to perform the printing on the continuous form paper based on the synchronizing signal generated by the synchronizing signal generation unit, and
the second printer has:
a synchronizing signal reception unit that receives the synchronizing signal generated by the synchronizing signal generation unit from the first printer; and
a second controller that controls the second printer so as to perform the printing on the continuous form paper based on the synchronizing signal received by the synchronizing signal reception unit.

4. The print system according to claim 2,
wherein the first printer further has:
an error detection unit that, when an error occurs in the first printer, detects the error; and
an error transmission unit that transmits the error detected by the error detection unit to the second printer, and
the first controller controls the first printer so as to stop the printing on the continuous form paper when the error occurs in the first printer, and
the second printer further has an error reception unit that receives the error detected by the error detection unit from the first printer, and
the second controller controls the second printer so as to stop the printing on the continuous form paper based on the error received by the error reception unit.

5. The print system according to claim 3,
wherein the first printer and the second printer respectively have:
a conveyance unit that conveys the continuous form paper; and
an image forming unit that forms an image on the continuous form paper conveyed by the conveyance unit, and
the synchronizing signal generation unit generates a synchronizing signal for synchronization of the conveyance unit and a synchronizing signal for synchronization of the image forming unit.
